(19) United States
(12) Patent Application Publication
(10) Pub. No.: US 2025/0370791 A1
(43) Pub. Date: Dec. 4, 2025

(54) Systems and Methods for Dynamic Task Generation

(71) Applicant: Live Oak Banking Company, Wilmington, NC (US)

(72) Inventor: Jeffrey Michael Nelson, Matthews, NC (US)

(21) Appl. No.: 18/680,432

(22) Filed: May 31, 2024

(51) Int. Cl. G06F 9/48; G06F 16/215; G06F 16/23

(52) U.S. Cl. CPC G06F 9/485; G06F 16/215; G06F 16/2365

(57) ABSTRACT

Systems and methods for ephemeral dynamic task generation. The system can receive from a user computing device, a user request query associated with contextual information. The method includes determining, based on the user request query, computing instructions defining one or more parameters to satisfy the user request query. The method includes inputting the computing instructions into a task generator, wherein the task generator, in response to the computing instructions, is configured to generate one or more executable tasks associated with satisfying the user request query in accordance with the one or more parameters. The method includes generating a real-time communication channel between a computing system and the user computing device. The method includes transmitting, over the real-time communication channel, one or more command instructions to update a user interface of the user computing device to display the one or more executable tasks.

### FIELD

The present disclosure generally relates to techniques for dynamically generating executable tasks for data capture by a computing system.

### BACKGROUND

Traditional forms may be used by service providers to capture standard information from its users, customers, or clients. For instance, a user intending to inquire about services or products from a service provider may complete one or more forms at the onset of the inquiry to provide the service provider with information needed to properly respond to the request.

### SUMMARY

Aspects and advantages of embodiments of the present disclosure will be set forth in part in the following description, or may be learned from the description, or may be learned through practice of the embodiments.

In an example aspect, the present disclosure provides an example computing system. The example computing system includes one or more processors and one or more non-transitory, computer readable medium storing instructions that are executable by the one or more processors to cause the computing system to perform operations. The example operations include receiving, from a user computing device, a user request query associated with contextual information. The example operations include determining, based on the user request query, computing instructions defining one or more parameters to satisfy the user request query. The example operations include inputting the computing instructions into a task generator, wherein the task generator, in response to the computing instructions, is configured to generate one or more executable tasks associated with satisfying the user request query in accordance with the one or more parameters. The example operations include generating a real-time communication channel between the computing system and the user computing device. The example operations include transmitting, over the real-time communication channel, one or more command instructions to update a user interface of the user computing device to display the one or more executable tasks.

In some implementations, the operations include receiving, over the real-time communication channel task execution data, the task execution data generated in response to an execution of the one or more executable tasks.

In some implementations, the operations include determining, based on the task execution data, updated contextual information. In some implementations the operations include determining, based on the updated contextual information, updated computing instructions defining one or more updated parameters. In some implementations, the operations include inputting the updated computing instructions into the task generator, wherein the task generator, in response to the updated computing instructions, is configured to generate one or more updated executable tasks associated with the updated contextual information.

In some implementations, the operations include validating the task execution data, wherein validating the task execution data comprises determining the task execution data satisfies at least one of (i) a data format, (ii) a data quality, or (iii) a data consistency.

In some implementations, the operations include, based on validating the task execution data, determining a status of the user request query, wherein the status is associated with an approval workflow.

In some implementations, the contextual information is indicative of a product or service associated with the user request query.

In some implementations, the product or service are associated with a financial product or financial service.

In some implementations, the operations include accessing data indicative of one or more previous user request queries, wherein the previous user request queries are associated with one or more previously executed tasks. In some implementations, the operations include computing, based on the previously executed tasks and the one or more executable tasks, at least one incomplete executable task.

In some implementations, computing the at least one incomplete executable task comprises determining one or more duplicate executable tasks.

In some implementations, the computing instructions comprise one or more nested computing instructions, the one or more nested computing instructions indicative of at least two types of contextual information.

In some implementations, the one or more nested computing instructions consolidate at least one executable task common across the at least two types of contextual information.

In some implementations, the operations include based on the user request query, determining a plurality of types of contextual information. In some implementations, the operations include, in response to determining the plurality of types of contextual information, programmatically generating the computing instructions, wherein the computing instructions synthesizes a set of non-duplicative executable tasks across the plurality of types of contextual information.

In some implementations, programmatically generating the computing instructions includes computing, a correlation between at least a first type of contextual information, a second type of contextual information, and respective parameters. In some implementations, programmatically generating the computing instructions includes based on the correlation, determining additional or duplicative executable tasks between the first type of contextual information, the second type of contextual information, and the respective parameters. In some implementations, programmatically generating the computing instructions includes generating the computing instructions in accordance with the respective parameters.

In another example aspect, the present disclosure provides an example computer-implemented method. The example computer-implemented method includes receiving, from a user computing device, a user request query associated with contextual information. The method includes determining, based on the user request query, computing instructions defining one or more parameters to satisfy the user request query. The method includes inputting the computing instructions into a task generator, wherein the task generator, in response to the computing instructions, is configured to generate one or more executable tasks associated with satisfying the user request query in accordance with the one or more parameters. The method includes generating a real-time communication channel between a computing system and the user computing device. The method includes transmitting, over the real-time communication channel, one or more command instructions to update a user interface of the user computing device to display the one or more executable tasks.

In some implementations, the method includes receiving, over the real-time communication channel task execution data, the task execution data generated in response to an execution of the one or more executable tasks.

In some implementations the method includes determining, based on the task execution data, updated contextual information. In some implementations, the method includes determining, based on the updated contextual information, updated computing instructions defining one or more updated parameters. In some implementations, the method includes inputting the updated computing instructions into the task generator, wherein the task generator, in response to the updated computing instructions, is configured to generate one or more updated executable tasks associated with the updated contextual information.

In some implementations the method includes validating the task execution data, wherein validating the task execution data comprises determining the task execution data satisfies at least one of (i) a data format, (ii) a data quality, or (iii) a data consistency.

In some implementations, the method includes, based on validating the task execution data, determining a status of the user request query, wherein the status is associated with an approval workflow.

In some implementations, the contextual information is indicative of a product or service associated with the user request query.

In another example aspect, the present disclosure provides an example non-transitory computer-readable medium storing instructions that are executable to cause one or more processors to perform operations. The example operations include receiving, from a user computing device, a user request query associated with contextual information. The example operations include determining, based on the user request query, computing instructions defining one or more parameters to satisfy the user request query. The example operations include inputting the computing instructions into a task generator, wherein the task generator, in response to the computing instructions, is configured to generate one or more executable tasks associated with satisfying the user request query in accordance with the one or more parameters. The example operations include generating a real-time communication channel between the computing system and the user computing device. The example operations include transmitting, over the real-time communication channel, one or more command instructions to update a user interface of the user computing device to display the one or more executable tasks.

Other example aspects of the present disclosure are directed to other systems, methods, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example data flow pipeline according to example aspects of the present disclosure.

FIG. 2 depicts an example data flow pipeline according to example aspects of the present disclosure.

FIG. 3 depicts an example two-way communication channel according to example aspects of the present disclosure.

FIG. 4 depicts an example user interface according to example aspects of the present disclosure.

FIG. 5 depicts an example flowchart diagram of an example method according to example aspects of the present disclosure.

FIG. 6 depicts an example computing ecosystem according to example aspects of the present disclosure.

### DETAILED DESCRIPTION

The present disclosure relates generally to a dynamic task generation engine. More particularly, the present disclosure relates to dynamically generating one or more tasks based on user input provided by a user. For instance, a user may submit a user request query through a user computing system. The user request query may be associated with contextual information indicating a particular product or service. Based on the contextual information, one or more associated blueprints in the form of computing instructions may be accessed or generated and inputted into a task engine. The task engine may execute the computing instructions and generate one or more executable tasks. The executable tasks may be presented to the requesting user and utilized to obtain information needed to provide the product or service to the user. For instance, the information captured through the completion of the tasks can be received by the service provider or associated with additional blueprints and utilized by the task engine to generate additional executable tasks.

Generating predetermined tasks or using tree-structures can be prohibitively difficult. Furthermore, modifying existing forms with complex decision trees, and/or creating new forms which integrate with complex forms, can be a challenge due to increased dependencies on previous responses and inability to remove duplicative tasks common across various branches. For example, service providers that provide technically complex services (e.g., financial transactions, medical records, etc.) may maintain thousands of forms (or more) created to obtain various types of information from users. However, changes made to products or services offered by such service providers can result in corresponding changes to some (or all) of the forms being maintained by the service provider, which can be prohibitively expensive. Moreover, forms may be repetitive across different products or services causing the user to complete duplicative forms or provide redundant information. This may increase storage costs and consume considerable computing resources to processes and maintain duplicative data adversely impacting the computing system while also providing a poor user experience. Additionally, these forms generally cannot be dynamically modified using conventional approaches. As such, service providers are forced to make certain input fields required even if the fields are only applicable to a small subset of users or services, thus forcing most users to enter redundant information by completing redundant tasks. Ultimately, this can waste valuable processing, memory, and power resources, as the computing systems work to process the redundant information.

Accordingly, implementations of the present disclosure propose a task generation engine that can be utilized to dynamically generate tasks based on the response received from a user. For example, a computing system for a service provider can implement forms to obtain initial request information from users. The computing system can analyze the user request query and determine contextual information associated with the request query. The contextual information can include information that describes particular products or services associated with the request query. In some examples the contextual information can include certain characteristics of the user making the request (e.g., name, address information, user account information, preferences, prior authorizations, etc.). Additionally, or alternatively, the contextual user information can include information received from the user via an input field of an existing form being rendered by a user computing device (e.g., a prior form in a series of forms).

Based on the contextual information from the user input, a task engine can associate the user request query with one or more blueprints to generate an executable task or a series of executable tasks for the user to complete. As described herein, the term “blueprint” can mean computing instructions that are executable to perform one or more tasks. A blueprint can be associated with a particular product or service and include computing instructions to generate executable tasks needed to provide the product or service to the user. In some examples, the blueprints may be predetermined. In other examples, the blueprints may be generated on-demand, in response to user input.

By way of example, a user may enter into an input field “loan” on an initial user request query. A “loan” blueprint (e.g., computing instructions) may be associated with a financial loan product and may include instructions to generate executable tasks associated with the loan product. For instance, a disclosure acknowledgment task, a credit inquiry task, and a financial history tasks may be associated with the “loan” blueprint. In response to the contextual information indicating a loan product, an associated “loan” blueprint may be selected or generated and input into a task engine. To facilitate communications, the computing system may establish a two-way communication channel between the user computing device and the computing system for the service provider. The two-way communication channel may be a persistent or ephemeral communication channel that enables real-time communications. The task engine may execute the associated computing instruction to generate the associated executable tasks and utilize the two-way communication to transmit the executable tasks to the user computing device in real-time. For instance, a user interface display of the user computing device may be updated in real-time to display the executable tasks as they are generated. As the user provides user input, the computing system may iteratively analyze the user input to determine whether additional tasks are needed. For instance, task execution data (e.g., data captured as a result of an executed task) may be analyzed and associated with blueprints.

By way of example, the task engine may determine the user input is associated with multiple products or services. For instance, the user may provide a user request query or task execution data indicating interest in a brokerage account and a loan. As such, a first blueprint associated with a “brokerage account” and a second blueprint associated with a “loan” may be inputted into the task generator. Based on the blueprints, the task generator may determine duplicative tasks and generate tasks which consolidate the common tasks across the brokerage account and loan products. The computing system can then generate an updated blueprint (e.g., updated computing instructions) which includes only unique executable tasks across the brokerage account and loan products. The updated computing instructions can then be inputted into the tasks generator to generate output communicated over the two-way communication channel to dynamically render a user interface of the user computing device to display the unique executable tasks across the brokerage account and loan products in real-time. In such fashion, the computing system can modify and/or generate computing instructions from which forms (e.g., executable tasks, etc.) can be dynamically rendered in real-time using the two-way communication channel. By dynamically generating tasks, the computing system can eliminate the collection of redundant information by tailoring tasks to specific users and their specific requests.

It should be noted that implementations described herein discuss the collection and utilization of various types of data. Any mention of data associated with users, as described herein, can be securely stored and protected against any type of unauthorized use or access. In addition, sensitive information, such as user data, is collected only with the express permission of said users. Users are provided the option to opt-out, or otherwise opt-in, to collection of such data.

Aspects of the present disclosure provide a number of technical effects and benefits. As one example technical effect and benefit, implementations of the present disclosure can substantially reduce the time required for users to complete online forms, thus increasing user satisfaction and substantially reducing compute resources necessary to collect such information from users. For example, using conventional techniques, most online forms must necessarily collect redundant information from users to provide coverage for niche scenarios (e.g., regulatory information for a particular state, etc.). However, by dynamically generating tasks and rendering forms in real-time, the present disclosure can efficiently tailor forms to users, eliminating the need to acquire redundant information and thus substantially reducing compute resources utilized to provide forms to users (e.g., power, memory, storage, compute cycles, etc.).

As another example technical effect and benefit, implementations of the present disclosure can substantially reduce utilization of compute resources for providing forms to users. Specifically, a conventional online form is rendered and then stored to a computing system of a service provider. The rendered form can be transmitted to a user computing device so that the user can input information to the form. However, implementations of the present disclosure can be utilized to dynamically create tasks to which a form can be dynamically rendered by a user computing device. By only transmitting instructions, rather than a rendered online form, implementations of the present disclosure can substantially reduce network bandwidth utilization and storage resource utilization.

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations may be made to the embodiments without departing from the scope of the present disclosure. For instance, features illustrated or described as part of one embodiment may be used with another embodiment to yield a still further embodiment. Thus, it is intended that aspects of the present disclosure cover such modifications and variations.

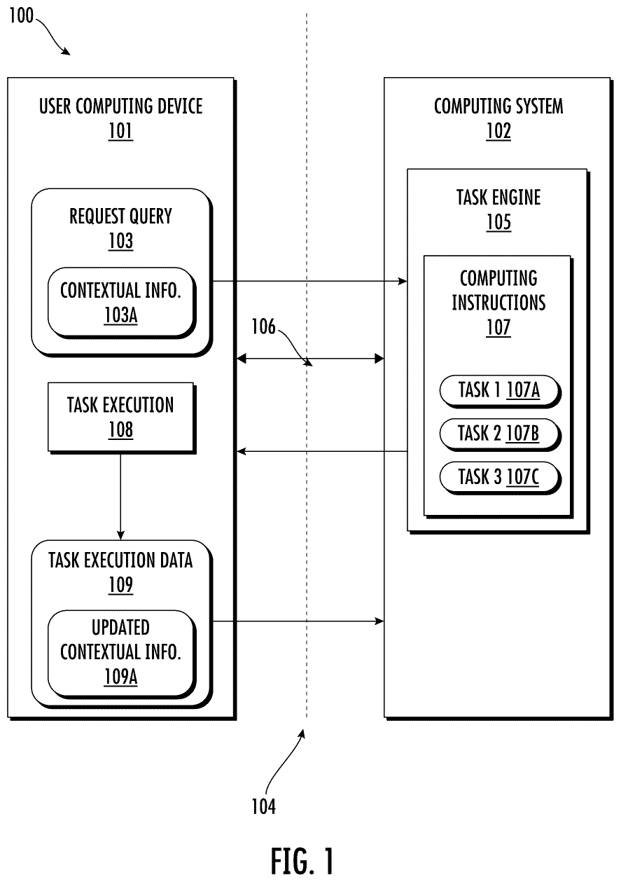

FIG. 1 depicts an example data flow pipeline according to example aspects of the present disclosure. The following description of dataflow pipeline 100 is described within an example implementation in which a user computing device 101 transmits a request query 103 to a computing system 102 and a two-way communication channel 106 is established to facilitate real-time communications between the user computing device 101 and the computing system 102. In an embodiment, the request query 103 may be received by a task engine 105 running on one or more servers of the computing system 102. In response to the request query 103, the task engine 105 may be configured to generate executable tasks 107A-C and transmit the executable tasks 107A-C via the two-way communication channel 106 to the user computing device 101 for execution. Once the executable tasks 107A-C have been executed (e.g., task execution 108), task execution data 109 may be generated and transmitted to the computing system 102 for further processing.

The user computing device 101 may include a computing device owned or otherwise accessible to a user. For instance, the user computing device 101 may include a phone, laptop, tablet, wearable device (e.g., smart watch, smart glasses, headphones), personal digital assistant, gaming system, personal desktop devices, other hand-held devices, or other types of mobile or non-mobile user devices. As further described herein, the user computing device 101 may include one or more input components such as buttons, a touch screen, a joystick or other cursor control, a stylus, a microphone, a camera or other imaging device, a motion sensor, etc. The user computing device 101 may include one or more output components such as a display device (e.g., display screen), a speaker, etc. In an embodiment, the user computing device 101 may include a component such as, for example, a touchscreen, configured to perform input and output functionality to receive user input and present information for the user. The user computing device 101 may execute one or more instructions to run an instance of a software application or a web browser and present user interfaces associated therewith, as further described herein. In an embodiment, the launch of a software application or web browser may initiate a user-network session (e.g., two-way communication channel 106, etc.) with the computing system 102.

For instance, the user computing system 101 and the computing system 102 may communicate over one or more networks 104. In an embodiment, the user computing system 101 and the computing system 102 may communicate according to a client-server relationship. The networks 104 may be any type of network or combination of networks that allows for communication between devices. In some implementations, the networks 104 may include one or more of a local area network, wide area network, the Internet, secure network, cellular network, mesh network, peer-to-peer communication link or some combination thereof and may include any number of wired or wireless links. Communication over the networks 104 may be accomplished, for instance, via a network interface using any type of protocol, protection scheme, encoding, format, packaging, etc. In an embodiment, communication between the user computing device 101 and the computing system 102 may be facilitated by near field or short range communication techniques (e.g., Bluetooth low energy protocol, radio frequency signaling, NFC protocol).

In an embodiment, the user computing device 101 and the computing system 102 may communicate using a long-lasting connection to allow for real-time communications. For instance, the computing system 102 may be configured, in response to a request query 103, to generate two-way or bidirectional communication channel. Example two-way communication channels may include, but are not limited to WebSocket, Server-Sent Events (SSE), Long Polling, Message Queuing Telemetry Transport, (MQTT), Web Real-Time Communications (WebRTC), etc.

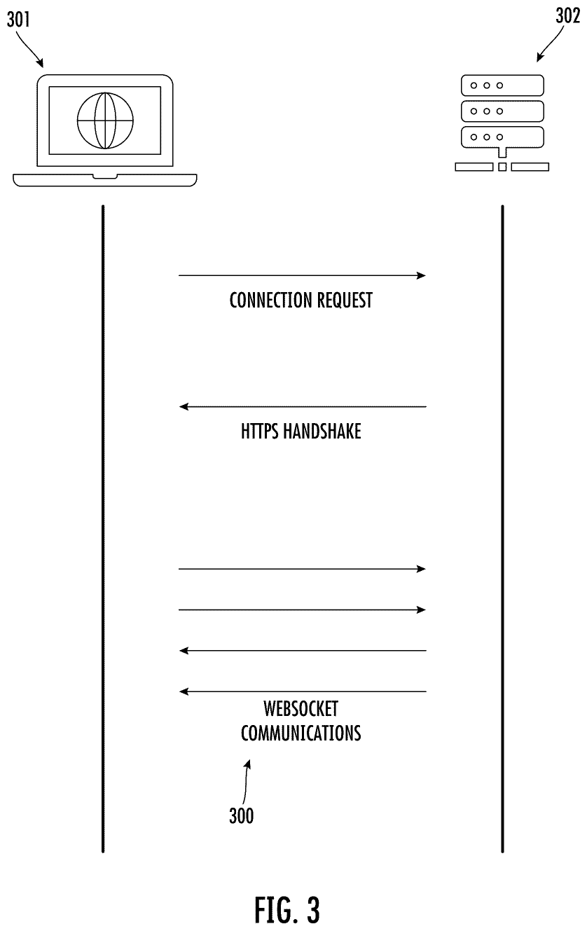

By way of example, in response to a request query 103, the computing system 102 may generate a persistent two-way communication channel 106. The two-way communication channel 106 may allow for real-time communications between the computing system 102 and the user computing device 101 as long as the user computing device 101 maintains an active session (e.g., browser session, active authentication token, etc.). In an embodiment, the real-time communications may enable a user interface of the user computing device 101 to be updated in real-time in response to the request query 103 and user input. An example of the two way communication channel 106 is further described with reference to FIG. 3

While examples herein describe a persistent or long-lasting communication channel, the present disclosure is not limited to such embodiment. For instance, the user computing device 101 and the computing system 102 may communicate using one or more application programming interfaces (APIs). This may include external facing APIs to communicate data from one system/device to another. The external facing APIs may allow the systems/devices to establish secure communication channels via secure access channels over the networks 104 through any number of methods, such as web-based forms, programmatic access via RESTful APIs, Simple Object Access Protocol (SOAP), remote procedure call (RPC), scripting access, etc.

The user computing device 101 may transmit a request query 103 over the networks 104 to the computing system 102. The request query 103 may include data generated in response to user input indicating a request for a product or service. For example, a user may interact with the user computing device 101 and access an application or a web browser. The application or web browser may be a client in a client-server relationship enabling the user to submit requests (e.g., over the one or more networks 104) to one or more servers of the computing system 102.

By way of example, a user may access a form via a web application and provide user input by submitting information associated with a request for products or services. The submission of the form may cause a request query 103 (e.g., API request, etc.) to be transmitted to the computing system 102. For instance, the request query 103 may include a digital request for information using any number of methods, such as web-based forms, programmatic access via RESTful APIs, Simple Object Access Protocol (SOAP), remote procedure call (RPC), scripting access, etc.

The request query 103 may include contextual information 103A. Contextual information 103A may be indicative of a particular product or service associated with the user request query 103. For instance, contextual information 103A may be within the body of the request query 103 and indicate a specific product or service the user has expressed interest in. For example, the form or questionnaire completed by the user via the user computing device 101 may indicate an intent to apply for a financial loan and open a savings account with a financial service provider. The request query 103 and the contextual information 103A may be transmitted to one or more servers of the computing system 102. The computing system 102 may be configured to receive the request query 103 and provide a response.

For example, the computing system 102 may include a cloud-based server system. The computing system 102 may be associated with a service provider. The computing system 102 may include one or more servers within a client-server relationship with the user-computing device 101 allowing for interactions with the user computing device 101. By way of example, the computing system 102 may be associated with a financial service provider that is responsible for offering and facilitating financial services or products to users. The computing system 102 may include one or more back-end services for offering services or products. The services may include, for example, financial loans, investment accounts, financial advisement, etc. The computing system 102 may host or otherwise include one or more APIs for communicating data to/from the computing system 102 to the user computing device 101, various third-parties, or other external entities.

The computing system 102 may include one or more computing devices. For instance, the computing system 102 may include a control circuit and a non-transitory computer-readable medium (e.g., memory). The control circuit of the computing system 102 may be configured to perform the various operations and functions described herein. Further description of the computing hardware and components of computing system 102 is provided herein with reference to other figures.

In an embodiment, the computing system 102 may include one or more subsystems. For instance, the computing system 102 may include a task engine 105. The task engine 105 may include software running on one or more servers of the computing system. The task engine 105 may be configured to execute computing instructions 107 and generate executable tasks 107A-C. For instance, the task engine 105 may store a plurality of pre-scripted or dynamically generated software computing instructions 107. The computing instructions 107 may be one or more functions configured to perform one or more actions. The computing instructions 107, once processed by the task engine 105 may cause the task engine to generate a plurality of executable tasks 107A-C. The executable tasks 107A-C may be associated with contextual information 103A included in the request query 103 and indicate clarifying or additional information needed from the user to respond to the request for products or services.

By way of example, the task engine 105, in response to the request query 103 may be configured to determine, based on the request query 103 an associated set of computing instructions 107 defining one or more parameters to satisfy the user request query 103. For instance, the contextual information 103A may indicate the user is requesting a financial loan. In an embodiment, the financial loan product may require standard or default information (e.g., one or more parameters) from the user in addition to the information provided by the request query 103 in order to process the request. As such, the computing system 102, based on the request query 103 (e.g., contextual information 103A) may access one or more sets of computing instructions 107 associated with the financial loan product which satisfy the one or more parameters. The one or more sets of computing instructions 107 associated with the financial loan product may be input into the task engine 105. The task engine 105 may execute the one or more sets of computing instructions 107 and output one or more executable tasks 107A-C. The executable tasks 107A may include software instructions, which, once transmitted to the user computing device 101 (e.g., via the two way communication channel 106) cause the user computing device 101 to render a user interface which prompt the user to provide the standard or default information associated with the financial loan product. In this way, the one or more parameters (e.g., which must be satisfied to respond to the request query 103) may be satisfied once the one or more executable tasks 107A-C have been executed.

For example, the computing system 102, in response to the request query 103 may configured to generate a two-way communication channel 106 to transmit the executable tasks 107A-C to the user computing device 101 in real-time. In an embodiment, two-way communication channel 106 may enable real-time communications between the user computing device 101 and the computing system 102. As such, a user interface of the user computing device 101 may be updated in real-time based on input (e.g., request query 103, etc.) provided by the user. An example of a two-way configuration channel is further described with reference to FIG. 3.

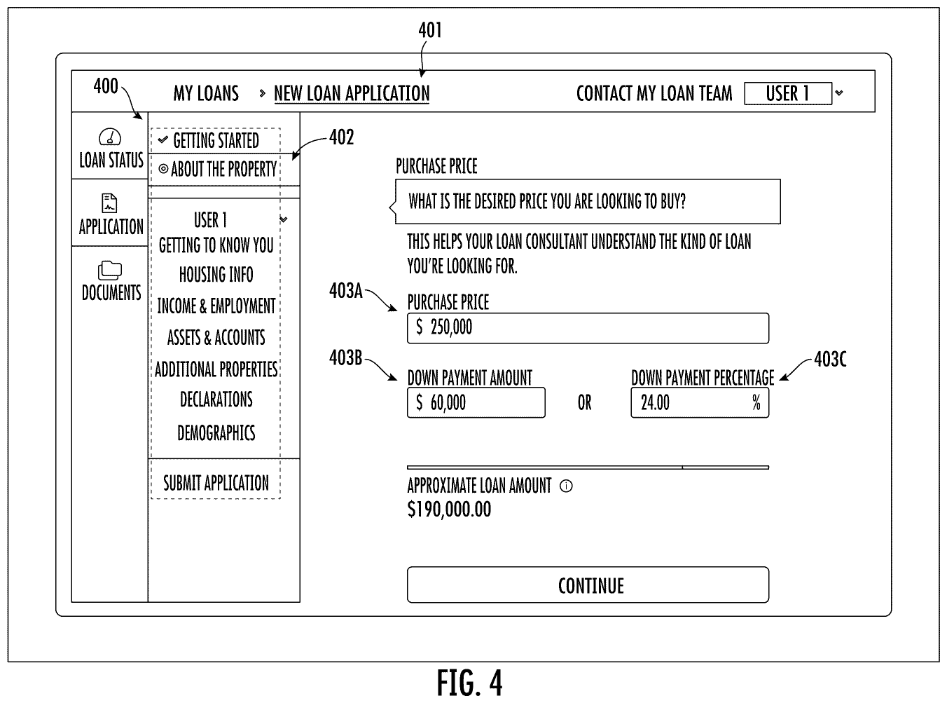

The user computing device 101 may receive (e.g., via the two-way communication channel 106) the executable tasks 107A-C and the user computing device 101 may render the user interface to display the executable tasks 107A-C. In an embodiment, the executable tasks 107A-C may cause the user interface of the user computing device 101 to be updated or refreshed to display the assigned executable tasks 107A-C. In other embodiments, the executable tasks 107A-C may cause the user interface of the user computing device 101 to render a new user interface (e.g., web page etc.). An example user interface of executable tasks is further described with reference to FIG. 4.

The user computing device 101 may include a task execution module 108 configured to receive the executable tasks 107A-C (e.g., via the two-way communication channel 106), track the status or progress of the executable tasks 107A-C, and generate tasks execution data 109. The tasks execution module 108 may include software being executed by one or more processors of the user computing device 101. For instance, the task execution module 108 may be included as software within the application client running on the user computing device 101. In an embodiment, the task execution module 108 may be stored in local memory (e.g., of the user computing device 101) or execute ephemerally (e.g., during the active user session). For instance, the task execution module 108 may be configured to track the overall status of the request query 103 and the status of the respective executable tasks 107A-C through its processing lifecycle. The status may be stored locally on the user computing device 101 or stored within one or more data stores within the computing system 102 where it may be accessed by the task execution module 108.

The tasks execution module 108 may receive the executable tasks 107A-C and actively generate task execution data 109 as the user executes the executable tasks 107A-C. For instance, the user may be prompted with a first executable task 107A which instructs the user to complete a disclosure form. The user may complete the disclosure form and the task execution module 108 may generate task execution data 108 indicating the first executable task 107A has been completed. In an embodiment, the task execution module 108 may update the status of the first executable task 107A to completed once executed. In another embodiment, the task execution module 108 may track and update the status of all executable tasks 107A-C until each have been completed.

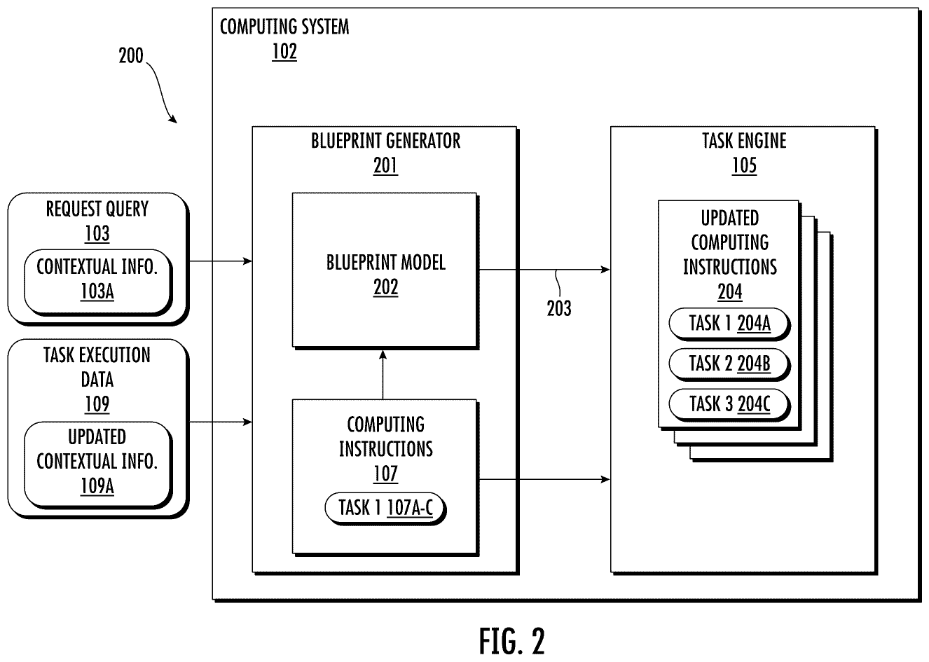

In an embodiment, the task execution module 108 may associate the executable tasks 107A-C with a task identifier (e.g., task_id). The task identifier may identify each unique executable task 107A-C. In an embodiment, the task identifier may indicate executable tasks 107A-C assigned to a particular user. For instance, the task identifier may be used to determine whether the user has already completed a particular tasks. Duplicative executable tasks 107A-C may be filtered from the executable tasks 107A-C presented to the user by the task execution module 108 or by the task engine 105. An example of filtering duplicative executable tasks 107A-C is further described with reference to FIG. 2.

In an embodiment, the task execution module 108 may validate the user input provided by the user by applying validation rules. Validation rules may include, but are not limited to a data format, a data quality, or a data consistency. Data format may include user input which is not formatted properly (e.g., numbers instead of characters, etc.). Data quality may include incomplete information (e.g., missing fields, missing data, etc.). Data consistency may include contradicting data (e.g., data stored in different locations do or do not match, etc.).

By way of example, the task execution module 108 may be configured to capture the user input (e.g., within fields, dropdowns, multiple select options, etc.) and generate task execution data 109. Task execution data 109 may include any digital message (e.g., API calls, messages, etc.) which can be transmitted over a network (e.g., network 104, two-way communication channel 106, etc.). For instance, the task execution module 108 may, in response to user input executing one or more executable tasks 107A-C, may generate messages to transmit via the two-way communication channel 106. The messages may include a message body including the user input (e.g., integers, strings, floats, arrays, etc.) input by the user. The messages may be validated prior to transmitting the message.

For example, the user may be prompted with a second executable task 107B instructing the user to provide financial statements such as income. If the user inputs a string value (e.g., letters, special characters, etc.), the task execution module 108 may reject the user input by displaying an error message or providing other indications to inform the user of the appropriate format such as integers (e.g., that satisfy the validation rules) of the user input.

The user may execute each of the assigned executable tasks 107A-C by providing user input and the task execution module 108 may validate the user input, generate task execution data 109, and transmit the task execution data 109 via the two-way communication channel 106 to the computing system 102. In an embodiment, the computing system 102 may trigger an approval workflow process to review the request query 103 and the task execution data 109. The approval workflow process may be a review by personnel associated with the service provider or may include an automated workflow. The approval workflow may facilitate a final or preliminary response to the user's request for products or services.

In an embodiment, the approval workflow process may trigger additional executable tasks 107A-C to be generated by the task engine 105. For instance, upon review of the task execution data 109 clarifying information may be needed to respond to the user's request for products or services. As such one or more additional executable tasks 107A-C may be generated to instruct the user to provide such clarifying or additional information. By way of example, the user may have executed a third executable task 107C providing two months of financial statements. Upon review of the request for a financial loan and other considerations, three months of financial statements may be needed to respond to the user's request. In an embodiment, the approval workflow, may trigger the task engine 105 to generate a fourth executable tasks to instruct the user to provide an additional financial statement.

In an embodiment, the tasks execution data 109 may trigger the task engine 105 to dynamically generate one or more sets of computing instructions 107 based on user input captured and transmitted by the task execution module 108. For example, the user may execute an executable task 107A-C and indicate interest in an additional product or service (e.g., updated contextual information 109A, etc.) not included in the request query 103 (e.g., initial request). A blueprint generator may be configured to analyze the task execution data 109 including the updated contextual information 109A) and generate updated computing instructions (e.g., updated blueprints). The updated computing instructions may filter duplicative tasks 107A-C across the additional products or services. An example of a blueprint generator is further described with reference to FIG. 2.

FIG. 2 depicts an example data flow pipeline according to example aspects of the present disclosure. The following description of dataflow pipeline 200 is described within an example implementation in which a blueprint generator 201 programmatically generates computing instructions 107 and updated computing instructions 204. The blueprint generator 201 may include a blueprint machine-learned model 202 which may iteratively improve the accuracy of the programmatically generated computing instructions 107 or updated computing instructions 204.

The blueprint generator 201 may include software running or one or more servers of the computing system 102. In an embodiment, the blueprint generator 201 may include a data repository or have access to a data repository where computing instructions 107 are stored. For instance, the blueprint generator 201 may include software configured to store pre-defined or pre-scripted computing instructions 107. By way of example, the computing instructions 107 may be scripted for existing products or services offered by the service provider. For instance, routine executable tasks 107A-C may be scripted and input into the task engine 105 when a request query 103 (e.g., contextual information 103A) indicate a request for the particular product or service.

In an embodiment, the blueprint generator 201 may programmatically generate computing instructions 107. For example, a user may submit a request query 103 and may indicate a plurality of products or services (e.g., multiple types of contextual information 103A). The blueprint generator 201 may be configured to, in response to the request query 103 indicating a plurality of products or services, access a plurality of sets of computing instructions 107 associated with respective products or services of the plurality of products or services. The blueprint generator 201 may analyze the computing instructions 107 for the respective products or services and determine duplicative executable tasks 107A-C across the plurality of products or services. For instance, the blueprint generator 201 may analyze the task_id associated with the respective computing instructions 107. Based on the task_id, the blueprint generator 201 may determine duplicative executable tasks 107A-C.

In an embodiment, the blueprint generator 201 may nest (e.g., generate parent child relationship) one or more computing instructions 107. Nested computing instructions 107 may concatenate one or more common task_ids (e.g., executable tasks 107A-C) across a plurality of computing instructions 107 (e.g., plurality of types of contextual information 103A) and consolidate the one or more executable tasks 107A-C. Consolidating the one or more executable tasks 107A-C may cause the status of all common executable tasks 107A-C to be updated in accordance with the parent executable tasks.

By way of example, a user may submit a request query 103 indicating a request for a business credit line, a brokerage account, and a business financial loan. The request for the business credit line, brokerage account, and business financial loan may be indicated by three types of contextual information 103A. The blueprint generator 201 may receive the request query 103 analyze the three types of contextual information 103A and access the computing instructions 107 associated with each. Based on the computing instructions 107 associated with each of the three types of contextual information, the blueprint generator 201 may determine there are two common executable tasks 107A-C (e.g., common task_ids) across the three types of contextual information 103A. The blueprint generator 201 may designate the computing instructions 107 associated with business credit line (e.g., contextual information 103A) as a master (e.g., parent) set computing instructions 107 and the computing instructions associated with the brokerage account and business financial loan as child computing instructions 107. For instance, the blueprint generator 201 may nest the computing instructions associated with the brokerage account and business financial loan into the computing instructions of the business credit line, such that a compiled set of executable tasks 107A-C across all sets of computing instructions 107 (e.g., the business credit line, brokerage account, and business financial loan) may be generated.

In an embodiment, the blueprint generator 201 may void the execution of the two common executable tasks 107A-C (e.g., common task_ids) associated with the child computing instructions 107 by the task engine 105 and import the concatenated status of the parent executable task 107A-C. As such only computing instructions 107 which result in unique executable tasks 107A-C (e.g., unique tasks_ids) may be transmitted to the task engine 105 for processing. Accordingly, the task engine 105 will preserve computing resources and avoid generating duplicative executable tasks 107A-C for the user. Furthermore, the user experience will be improved by avoiding duplicative data entry.

While examples herein describe nested computing instructions 107, the present disclosure is not limited to such embodiment and executable tasks 107A-C may be selected in an itemized manner to generate computing instructions 107. For instance, the blueprint generator 201 may determine the user is associated with an existing user profile. The user profile data may indicate that the user has already completed 7 of 10 executable tasks 107A-C associated with a request query 103 for a new product or service (e.g., contextual information 103A). Accordingly, the blueprint generator 201 may extract itemized computing instructions 107 associated with the new product or service which satisfies the remaining 3 of 10 executable tasks. As such the technology of the present disclosure preserves computing resources and improves user experience by generating only the executable tasks 107A-C needed to respond to the request query 103.

In an embodiment, a machine-learned blueprint model 202 may be used to generate output 203 indicative of updated computing instructions 204. The blueprint model 202 may be an unsupervised or supervised learning model configured to identify and measure a level of duplicative information captured across task execution data 109. In some examples, the blueprint model 202 may include one or more machine-learned models. For example, the blueprint model 202 may include a machine-learned model trained to detect duplicative information within task execution data 109. In some examples, the blueprint model 202 model may include a machine-learned model trained on request inquiries 103. In some examples, the blueprint model 202 may include a machine-learned model trained to predict future request inquiries 103.

The blueprint model 202 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The blueprint model 202 may be trained through the use of one or more model trainers and training data. The model trainers may be trained using one or more training or learning algorithms. One example training technique is backwards propagation of errors. In some examples, simulations may be implemented for obtaining the training data or for implementing the model trainer(s) for training or testing the model(s). In some examples, the model trainer(s) may perform supervised training techniques using labeled training data. As further described herein, the training data may include labelled task execution data 109 that have labels indicating duplicative information across executable tasks 107A-C. In some examples, the training data may include simulated training data (e.g., training data obtained from simulated scenarios, inputs, configurations, etc.).

Additionally, or alternatively, the model trainer(s) may perform unsupervised training techniques using unlabeled training data. By way of example, the model trainer(s) may train one or more components of a machine-learned model to perform redundant data entry detection through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The computing system 102 may utilize the blueprint model 202 to analyze request inquiries 103, task execution data 109, updated contextual information 109A, and existing (e.g., pre-scripted, etc.) computing instructions 107 to generate output 203 indicative of updated computing instructions 204.

For instance, the blueprint model 202 may receive as input a request query 103 indicating one or more types of contextual information 103A and computing instructions 107. The blueprint model 202 may analyze the computing instructions 107 associated with each types of contextual information 103A and determine duplicative executable tasks 107A-C (e.g., task_ids). In an embodiment, the blueprint model 202 may determine a duplication score indicative of a level of duplicative of information to be captured via the executable tasks 107A-C associated with the respective computing instructions 107. For example, the blueprint model 202 may determine direct duplication or indirect duplication across executable tasks 107A-C. Direct duplication may include identical task_ids associated with at least two sets of computing instructions 107. Indirect duplication may include similar data captured via executable tasks 10A-C. An example of indirect duplication may include a first executable task 107A instructing the user to provide a permanent address and a second executable task 107B instructing the user to provide a temporary address.

The blueprint model 202 may be configured to minimize the duplication score by modifying the computing instructions such that duplication of executable tasks 107A-C is reduced as the user submits additional request inquiries. For instance, the blueprint model 202 may generate output 203 indicative of updated computing instructions 204. The updated computing instructions 204 may include updated executable tasks 204A-C which reduce the level of duplication across the 107A-C executable tasks and the level of duplicated user input (e.g., task execution data 109).

In an embodiment, the blueprint model 202 may iteratively generate updated computing instructions 204 in response to task execution data 109 which includes updated contextual information 109A. For instance, the user may submit a request query 103, and in response to providing user input (e.g., to execute the executable tasks 107A-C), the user may indicate updated contextual information 109A (e.g., additional products, services, etc.). The blueprint model 202 may receive as input the task execution data 109 including the updated contextual information 109A and determine a duplication score across the executable tasks 107A-C already completed by the user or already generated and presented to the user. The blueprint model 202 may generate updated computing instructions 204 which minimize the duplication score across the computing instructions 107A-C associated with the newly identified products or services (e.g., updated contextual information 109A) such that the updated computing tasks 204A-C avoid presenting duplicative executable tasks 204A-C to the user. In this way the computing system 102 may dynamically respond and generate executable tasks 107A-C, updated executable tasks 204A-C, etc., which avoid duplicative responses. As such the computing system 102 may preserve computing resources and improve user experience.

In an embodiment, the blueprint model 202 may perform text analysis on user input to determine a duplication score. For instance, the blueprint model may perform natural language processing (NLP) to determine a duplication of user input at the field level. By way of example, the blueprint model 202 may analyze task execution data 109 for a “mobile phone” field in a first executable task 107A and a “home phone” field in a second executable task 107B. The blueprint model 202 may determine across a set of task execution data 109 or request inquiries 103 across a plurality of users a high duplication score between the “mobile phone” field and the “home phone” field. In an embodiment, the blueprint generator 201 may modify the computing instructions 107 to remove at least one of the fields within the first executable task 107A and the second executable task 107B.

While examples herein describe usage of NLP to determine field level duplication, the present disclosure is not limited to such embodiment. Any data analysis technology may be used as input to determine a duplication score.

FIG. 3 depicts an example two-way communication channel according to example aspects of the present disclosure. While examples herein depict a WebSocket two-way communication channel, the present disclosure is not limited to such embodiment and may be established over any real-time communication protocol. The example WebSocket communication channel 300 may be established between a client 301 and a server 302 over one or more networks such as the Internet. In an embodiment a computing system (e.g., computing system 102) may include one or more servers configured to “listen” (e.g., continuously wait) for any port (e.g., numbered connection endpoint, etc.) of a server which follows a specific protocol. By way of example the computing system 102 may include a TCP (transmission control protocol) server which listens for a TCP protocol to one or more ports of the computing system 102.

The client 301 may transmit a connection request over the one or more networks (e.g., network 104). The connection request may be associated with a request (e.g., API request, GET request, etc.) to interact with or request data stored within the server 302 (e.g., computing system 102). The connection request may include an HTTP request to at least one port associated with the servers 302. In an embodiment, the connection request may indicate a request to upgrade the connection from the HTTP protocol to a WebSocket communication 300 (e.g., two-way communication channel 106, etc.). The servers 302 may receive the connection request and initiate an HTTPS “handshake” indicating that the connection request has been verified. For instance, the server 302 may return a response code indicating the WebSocket communications 300 has been successfully established.

Once the WebSocket communications 300 have been established, the client 301 (e.g., user computing device 101, etc.) and the server 302 (e.g., computing system 102, etc.) may communicate using the WebSocket communications 300 in real-time. For instance, the WebSocket communications 300 may enable ongoing, full-duplex, bidirectional communication between a web client (e.g. client 301) and a web server (e.g., server 302) over an underlying TCP connection.

Once the persistent WebSocket connection 300 has served its purposes (e.g., communicating executable tasks 107A-C, updated executable tasks 204A-C, task execution data 109, etc.), the connection can be terminated. For instance, both the client 301 and the server 302 can initiate the closing handshake by sending a close message. In an embodiment, the connection may time out if there are no messages sent in a threshold duration of time. In another embodiment, the connection may terminate if conditions change (e.g., expiry of authentication, etc.).

The WebSocket communications 300 may be used to generate or update user interfaces of the user computing device 101 in real-time based on input provided by the user. For instance, executable tasks 107A-C or updated executable tasks 204A-C may cause the user computing device 101 to render a user interface to display the tasks to the user. An example of a user interface is further described with reference to FIG. 4.

FIG. 4 depicts an example user interface according to example aspects of the present disclosure. The example user interface 400 may be displayed via one or more user interface displays associated with the user computing device 101. The example user interface display 400 may be rendered (e.g., on a display device) based on computing instructions 107 or updated computing instructions 204 received by the user computing device 101.

The user interface 400 may include a plurality of interactable user interface elements. For instance, the user interface 400 may include a set of tasks (SOT) user interface element 402 (e.g., executable tasks 107A-C, updated executable tasks 204A-C, etc.). The SOT user interface element 402 may include a set of executable tasks assigned to the user based on the user input. In an embodiment the SOT user interface element 402 may be updated based on the task engine 105 generating executable tasks 107A-C and transmitting them via the two-way communication channel 106. For instance, the SOT user interface element 402 may be updated in real-time as the user provides user input (e.g., request query 103, task execution data 109, etc.).

In an embodiment, the user may interact with the SOT user interface element 402. For instance, the user may “click” or otherwise select an assigned task within the SOT user interface element 402 to begin execution of the task. Once the user has selected a task from the SOT user interface element 402, the user interface 400 may be updated to display a plurality of interactive input fields user interface elements 403A-C. The input fields user interface elements 403A-C may indicate a position within the user interface 400 where the user may provide user input. The user input may be captured by a task execution module 108 and utilized to validate the user input and generate task execution data 109 to be transmitted via the two-way communication channel 106 to the computing system 102.

By way of example, the user may select the “about the property” executable task user interface element from SOT user interface element 402. In response, the user interface 400 may display the input fields user interface elements 403A-C associated with the “about the property” executable task user interface element. In this way, the user is prompted to provide user input to the input fields user interface elements 403A-C in order to execute the “about the property” executable task. As the user matriculates through each of the input fields user interface elements 403A-C, the task execution module 108 may iteratively validate the user input, generate task execution data 109, and transmit the task execution data 109 via the two-way communication channel 106 to the computing system 102.

In an embodiment, the SOT user interface element 402 may be iteratively updated based on updated contextual information 109A which may cause the task engine 105 to generate updated executable tasks 204A-C (e.g., updated computing instructions 204). For instance, the SOT user interface element 402 may be updated to include additional tasks, remove existing tasks, or modify any of the input fields user interface elements 403A-C associated with a particular task in real-time. For instance, as the user executes executable tasks 107A-C, the SOT user interface element 402 may be iteratively updated in real-time.

In an embodiment, the user interface 400 may indicate informative content and a current status of the request query 103 to the user. For instance, the contextual information type user interface element 401 may indicate the type of contextual information 103A indicated by the request query 103. By way of example the contextual information type user interface element 401 may indicate the user is requesting a loan product. In an embodiment, a current status may be derived from the user interface elements. By way of example, the “getting started” task within the SOT user interface element 402 may include a check mark to indicate the task has been completed and the “about the property” user interface element within the SOT user interface element 402 may include an in progress indicator to indicate the task is currently in progress (e.g., the input fields user interface elements 403A-C are within view). The status of the request query 103 and the status of the respective tasks (e.g., within the SOT user interface element 402) may be stored or otherwise accessible to the task execution module 108 and utilized to maintain the current status indication.

In an embodiment, the user interface 400 may user interface element to trigger an approval workflow. For instance, a “submit application” user interface element within the SOT user interface element 402 may be updated to allow the user to interact (e.g., click, select, etc.) with once all of the preceding tasks within the SOT user interface element 402 have been completed. The selection of the “submit application” user interface element may trigger an approval workflow within the computing system 102 where the request query 103 may be reviewed either manually or programmatically to provide a response.

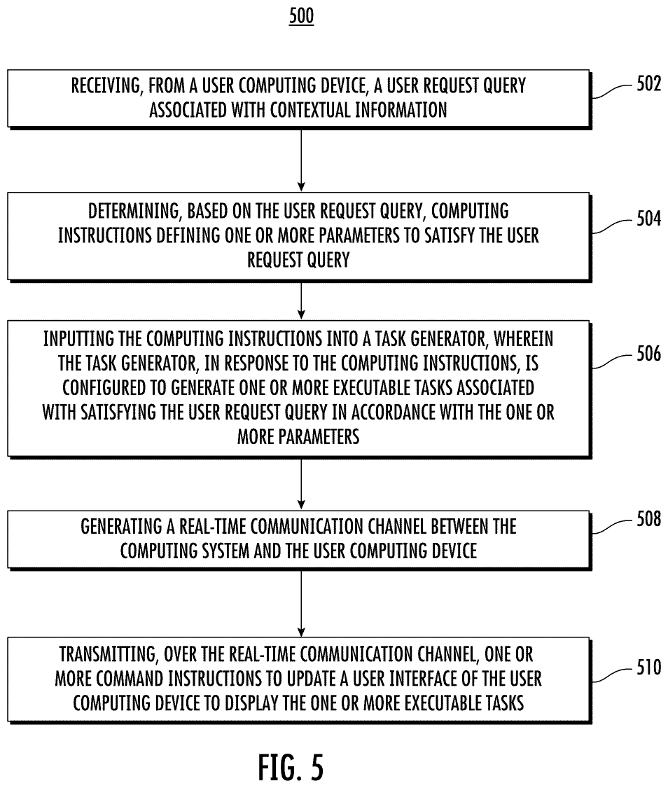

FIG. 5 depicts a flowchart diagram of an example method according to example aspects of the present disclosure. One or more portion(s) of the method 500 may be implemented by one or more computing devices such as, for example, the computing devices/systems described in FIGS. 1, 2, 3, 4, 6, etc. Moreover, one or more portion(s) of the method 500 may be implemented as an algorithm on the hardware components of the device(s) described herein. For example, a computing system may include one or more processors and one or more non-transitory, computer-readable media storing instructions that are executable by the one or more processors to cause the computing system to perform operations, the operations including one or more of the operations/portions of method 500. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

In an embodiment, the method 500 may include a step 502 or otherwise begin by receiving, from a user computing device, a user request query associated with contextual information. For instance, a user may provide user input via a web application or software application displayed via one or more user interfaces of the user computing device 101. The request query 103 may include contextual information 103A indicating one or more products or services requested by the user from a service provider.

In an embodiment, the method 500 may include a step 504 or otherwise continue by determining, based on the user request query, computing instructions defining one or more parameters to satisfy the user request query. For instance, the computing system 102 may analyze the request query 103 and access one or more sets of computing instructions 107 based on contextual information 103A. The sets of computing instructions 107 may be associated with a particular product or service (e.g., associated with the contextual information 103A) offered by the service provider. The computing system 102 may filter the one or more sets of computing instructions 107 based on parameters which define additional information or clarifying information needed from the user to respond to the request query 103. Parameters may include, but are not limited to, a set of executable tasks, matching task_ids, matching computing instructions identifiers, etc.)

By way of example, the contextual information 103A may indicate the user is requesting a financial loan. In an embodiment, the financial loan product may require standard or default information from the user in addition to the information provided by the request query 103 in order to process the request. As such, the computing system 102, based on the request query 103 (e.g., contextual information 103A) may access one or more sets of computing instructions 107 associated with the financial loan product. The computing system 102 may determine a set of searching parameters to filter the one or more sets of computing instructions 107 and access the computing instructions 107 which satisfy the parameters.

In an embodiment, the method 500 may include a step 506 or otherwise continue by, inputting the computing instructions into a task generator, wherein the task generator, in response to the computing instructions, is configured to generate one or more executable tasks associated with satisfying the user request query in accordance with the one or more parameters. For instance, the one or more sets of computing instructions 107 associated with the financial loan product (e.g., which satisfy the parameters) may be input into the task engine 105. The task engine 105 may execute the one or more sets of computing instructions 107 and output one or more executable tasks 107A-C. The executable tasks 107A may include software, which, once transmitted to the user computing device 101 (e.g., via the two way communication channel 106) render a user interface which prompt the user to provide the standard or default information associated with the financial loan product.

In an embodiment, the method 500 may include a step 508 or otherwise continue by generating a real-time communication channel between the computing system and the user computing device. By way of example a WebSocket communication channel 300 may be established between the user client device 101 and the computing system 102 over one or more networks such as the Internet. For instance, the computing system 102 may include a TCP (transmission control protocol) server which listens for a TCP protocol to one or more ports of the computing system 102. The user computing device 101 may transmit a connection request over the network 104). The connection request may be associated with a request (e.g., API request, GET request, etc.) to interact with or request data stored within the computing system 102. The connection request may include an HTTP request to at least one port associated with the servers 302. In an embodiment, the connection request may indicate a request to upgrade the connection from the HTTP protocol to a WebSocket communication 300 (e.g., two-way communication channel 106, etc.). The computing system 102 may receive the connection request and initiate an HTTPS “handshake” indicating that the connection request has been verified. For instance, the computing system 102 may return a response code indicating the WebSocket communications 300 has been successfully established.

In an embodiment, the method 500 may include a step 510 or otherwise continue by transmitting, over the real-time communication channel, one or more command instructions to update a user interface of the user computing device to display the one or more executable tasks. For instance, once the WebSocket communications 300 have been established, the user computing device 101 and the computing system 102 may communicate using the WebSocket communications 300 in real-time. For instance, the WebSocket communications 300 may enable ongoing, full-duplex, bidirectional communication between a web client (e.g. client 301) and a web server (e.g., server 302) over an underlying TCP connection.

The WebSocket communications 300 may be used to generate or update user interfaces of the user computing device 101 in real-time based on input provided by the user. For instance, executable tasks 107A-C or updated executable tasks 204A-C may cause the user computing device 101 to render a user interface to display the tasks to the user. The user may provide user input to generate task execution data 109 which may be transmitted back to the computing system 102.

Once the persistent WebSocket connection 300 has served its purposes (e.g., communicating executable tasks 107A-C, updated executable tasks 204A-C, task execution data 109, etc.), the connection can be terminated. For instance, both the client 301 and the server 302 can initiate the closing handshake by sending a close message. In an embodiment, the connection may time out if there are no messages sent in a threshold duration of time. In another embodiment, the connection may terminate if conditions change (e.g., expiry of authentication, etc.).

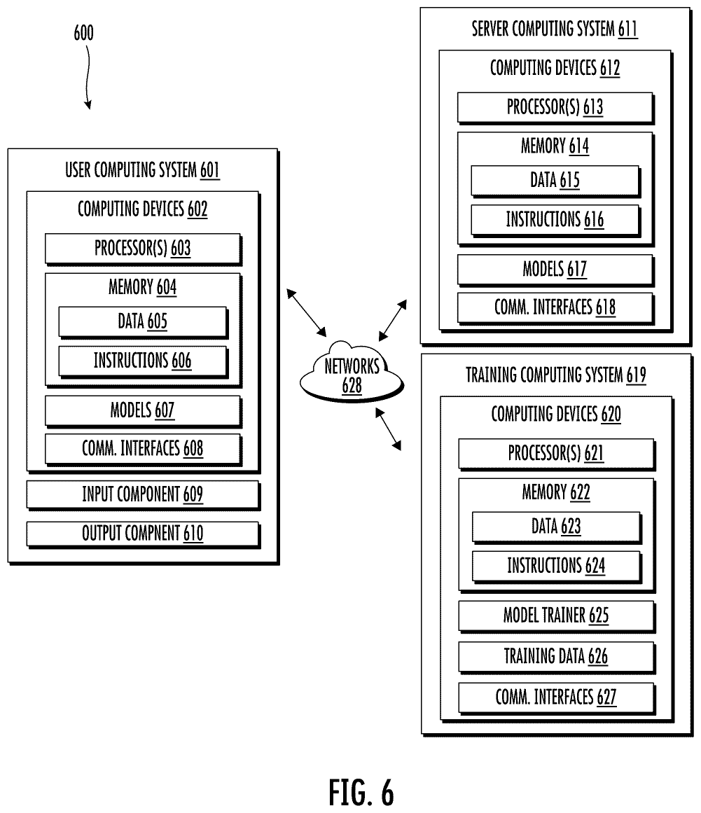

FIG. 6 depicts a block diagram of an example system 600 for implementing systems and methods according to example embodiments of the present disclosure. The system 600 includes a user computing system 601 (e.g., user computing device 101), a server computing system 611 (e.g., a computing system 102), and a training computing system 619 communicatively coupled over one or more networks 628.

The user computing system 601 may include one or more computing devices 602 or circuitry. For instance, the user computing system 601 may include one or more processors 603 and a memory 604. In an embodiment, the processors 603 may be any suitable processing device (e.g., a processor core, a microprocessor, an ASIC, a FPGA, a controller, a microcontroller, etc.) and may be one processor or a plurality of processors that are operatively connected. The memory 604 may include one or more non-transitory computer-readable storage media, such as RAM, ROM, EEPROM, EPROM, one or more memory devices, flash memory devices, etc., and combinations thereof.

The memory 604 may store information that may be accessed by the processors 603. For instance, the memory 604 (e.g., memory devices) may store data 605 that may be obtained, received, accessed, written, manipulated, created, and/or stored. The data 605 may include, for instance, any of the data or information described herein. In some implementations, the user computing system 601 may obtain data from one or more memories that are remote from the user computing system 601.

The memory 604 may also store computer-readable instructions 606 that may be executed by the processor(s) 603. The instructions 606 may be software written in any suitable programming language or may be implemented in hardware.

The instructions 606 may be executed in logically and/or virtually separate threads on the processor(s) 603. For example, the memory 604 may store instructions 606 that when executed by the processor(s) 603 cause the processor(s) 603 to perform any of the operations, methods and/or processes described herein. In some cases, the memory 604 may store computer-executable instructions or computer-readable instructions, such as instructions to perform at least a portion of the method of FIG. 5.

In an embodiment, the user computing system 601 may store or include one or more machine-learned models 607. For example, the machine-learned models 607 may be or may otherwise include various machine-learned models. In an embodiment, the machine-learned models 607 may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

In an embodiment, the one or more machine-learned models 607 may be received from the server computing system 611 over networks 628, stored in the user computing system 601 (e.g., memory 604), and then used or otherwise implemented by the processor(s) 603. In an embodiment, the user computing system 601 may implement multiple parallel instances of a single model.

Additionally, or alternatively, one or more machine-learned models 607 may be included in or otherwise stored and implemented by the server computing system 611 that communicates with the user computing system 601 according to a client-server relationship. For example, the machine-learned models 607 may be implemented by the server computing system 611 as a portion of a web service. Thus, one or more models 607 may be stored and implemented at the user computing system 601 and/or one or more models 607 may be stored and implemented at the server computing system 611.

The user computing system 601 may include one or more communication interfaces 1008. The communication interfaces 608 may be used to communicate with one or more other systems. The communication interfaces 608 may include any circuits, components, software, etc. for communicating via one or more networks (e.g., networks 628). In some implementations, the communication interfaces 608 may include for example, one or more of a communications controller, receiver, transceiver, transmitter, port, conductors, software and/or hardware for communicating data/information.

The user computing system 601 may also include one or more user input components 1009 that receives user input. For example, the user input component 609 may be a touch-sensitive component (e.g., a touch-sensitive user interface of a mobile device) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input.

The user computing system 601 may include one or more output components 610. The output components 610 may include hardware and/or software for audibly or visually producing content. For instance, the output components 610 may include one or more speakers, earpieces, headsets, handsets, etc. The output components 610 may include a display device, which may include hardware for displaying a user interface and/or messages for a user. By way of example, the output component 610 may include a display screen, CRT, LCD, plasma screen, touch screen, TV, projector, tablet, and/or other suitable display components.

The server computing system 611 may include one or more computing devices 612. In an embodiment, the server computing system 611 may include or is otherwise implemented by one or more server computing devices. In instances in which the server computing system 611 includes plural server computing devices, such server computing devices may operate according to sequential computing architectures, parallel computing architectures, or some combination thereof.

The server computing system 611 may include a processor(s) 613 and a memory 614, also referred to herein as memory 614. In an embodiment, the processors 613 may be any suitable processing device (e.g., a processor core, a microprocessor, an ASIC, a FPGA, a controller, a microcontroller, etc.) and may be one processor or a plurality of processors that are operatively connected. The memory 614 may include one or more non-transitory computer-readable storage media, such as RAM, ROM, EEPROM, EPROM, one or more memory devices, flash memory devices, etc., and combinations thereof. In an embodiment, the memory 614 may be a memory device, also referred to as a data storage device, which may include an electronic storage device, a magnetic storage device, an optical storage device, an electromagnetic storage device, a semiconductor storage device, or any suitable combination thereof. The memory may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The memory 614 may store information that may be accessed by the processor(s) 1013. For instance, the memory 614 (e.g., memory devices) may store data 615 that may be obtained, received, accessed, written, manipulated, created, and/or stored. The data 615 may include, for instance, any of the data or information described herein. In some implementations, the server computing system 611 may obtain data from one or more memories that are remote from the server computing system 611.

The memory 614 may also store computer-readable instructions 616 that may be executed by the processor(s) 613. The instructions 616 may be software written in any suitable programming language or may be implemented in hardware. The instructions may include computer-readable instructions, computer-executable instructions, etc.

The instructions 616 may be executed in logically and/or virtually separate threads on the processor(s) 613. For example, the memory 614 may store instructions 616 that when executed by the processor(s) 613 cause the processor(s) 613 to perform any of the operations, methods and/or processes described herein. In some cases, the memory 614 may store computer-executable instructions or computer-readable instructions, such as instructions to perform at least a portion of the methods of FIG. 5.

The server computing system 611 may store or otherwise include one or more machine-learned models 617. The machine-learned models 617 may include or be the same as the models 607 stored in user computing system 601. In an embodiment, the machine-learned models 617 may include an unsupervised learning model. In an embodiment, the machine-learned models 617 may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

The machine-learned models described in this specification may have various types of input data and/or combinations thereof, representing data available to user input devices and/or other systems. Input data may include, for example, user input (e.g., a request queries 103, task execution data 108, etc.), statistical data (e.g., data computed and/or calculated from some other data source), data processing analytics (e.g., NLP analytics, etc.), or other types of data.

The server computing system 611 may include one or more communication interfaces 1018. The communication interfaces 618 may be used to communicate with one or more other systems. The communication interfaces 618 may include any circuits, components, software, etc. for communicating via one or more networks (e.g., networks 628). In some implementations, the communication interfaces 618 may include for example, one or more of a communications controller, receiver, transceiver, transmitter, port, conductors, software and/or hardware for communicating data/information.

The user computing system 601 and/or the server computing system 611 may train the models 607, 617 via interaction with the training computing system 619 that is communicatively coupled over the networks 628. The training computing system 619 may be separate from the server computing system 611 or may be a portion of the server computing system 611.

The training computing system 619 may include one or more computing devices 1020. In an embodiment, the training computing system 619 may include or is otherwise implemented by one or more server computing devices. In instances in which the training computing system 619 includes plural server computing devices, such server computing devices may operate according to sequential computing architectures, parallel computing architectures, or some combination thereof.

The training computing system 619 may include a processor(s) 621 and a memory 1022, also referred to herein as memory 622. In an embodiment, the processors 621 may be any suitable processing device (e.g., a processor core, a microprocessor, an ASIC, a FPGA, a controller, a microcontroller, etc.) and may be one processor or a plurality of processors that are operatively connected. The memory 622 may include one or more non-transitory computer-readable storage media, such as RAM, ROM, EEPROM, EPROM, one or more memory devices, flash memory devices, etc., and combinations thereof.

In an embodiment, the memory 622 may be a memory device, also referred to as a data storage device, which may include an electronic storage device, a magnetic storage device, an optical storage device, an electromagnetic storage device, a semiconductor storage device, or any suitable combination thereof. The memory may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The memory 622 may store information that may be accessed by the processor(s) 1021. For instance, the memory 622 (e.g., memory devices) may store data 623 that may be obtained, received, accessed, written, manipulated, created, and/or stored. The data 623 may include, for instance, any of the data or information described herein. In some implementations, the training computing system 619 may obtain data from one or more memories that are remote from the training computing system 619.

The memory 622 may also store computer-readable instructions 624 that may be executed by the processor(s) 621. The instructions 624 may be software written in any suitable programming language or may be implemented in hardware. The instructions may include computer-readable instructions, computer-executable instructions, etc.

The instructions 624 may be executed in logically or virtually separate threads on the processor(s) 621. For example, the memory 622 may store instructions 624 that when executed by the processor(s) 621 cause the processor(s) 621 to perform any of the operations, methods and/or processes described herein. In some cases, the memory 622 may store computer-executable instructions or computer-readable instructions, such as instructions to perform at least a portion of the methods of FIG. 5.

The training computing system 619 may include a model trainer 625 that trains the machine-learned models 607, 617 stored at the user computing system 601 and/or the server computing system 611 using various training or learning techniques. For example, the models 607, 617 may be trained using a loss function. By way of example, for training a machine-learned blueprint model, the model trainer 625 may use a loss function. For example, a loss function can be backpropagated through the model(s) 607, 617 to update one or more parameters of the model(s) 607, 617 (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

The model trainer 625 may train the models 607, 617 (e.g., a machine-learned clustering model) in an unsupervised fashion. As such, the models 607, 617 may be effectively trained using unlabeled data for particular applications or problem domains, which improves performance and adaptability of the models 607, 617.

The training computing system 619 may modify parameters of the models 607, 617 (e.g., the blueprint model 202) based on the loss function such that the models 607, 617 may be effectively trained for specific applications in an unsupervised manner without labeled data.

The model trainer 625 may utilize training techniques, such as backwards propagation of errors. For example, a loss function may be backpropagated through a model to update one or more parameters of the models (e.g., based on a gradient of the loss function). Various loss functions may be used such as mean squared error, likelihood loss, cross entropy loss, hinge loss, and/or various other loss functions. Gradient descent techniques may be used to iteratively update the parameters over a number of training iterations.

In an embodiment, performing backwards propagation of errors may include performing truncated backpropagation through time. The model trainer 625 may perform a number of generalization techniques (e.g., weight decays, dropouts, etc.) to improve the generalization capability of a model being trained. In particular, the model trainer 625 may train the machine-learned models 607, 617 based on a set of training data 626.

The training data 626 may include unlabeled training data for training in an unsupervised fashion. In an example, the training data 626 may include unlabeled sets of data indicative of varying types of duplicative data (e.g., determining direct and indirect duplication). The training data 626 may be specific to a user or group of users to help focus the models 607, 617 on the particular user base.

In an embodiment, training examples may be provided by the user computing system 601 (e.g., user computing device 101). Thus, in such implementations, a model 607 provided to the user computing system 601 may be trained by the training computing system 619 in a manner to personalize the model 607.

The model trainer 625 may include computer logic utilized to provide desired functionality. The model trainer 625 may be implemented in hardware, firmware, and/or software controlling a general-purpose processor. For example, in an embodiment, the model trainer 625 may include program files stored on a storage device, loaded into a memory and executed by one or more processors. In other implementations, the model trainer 625 may include one or more sets of computer-executable instructions that are stored in a tangible computer-readable storage medium such as RAM, hard disk, or optical or magnetic media.

The training computing system 619 may include one or more communication interfaces 627. The communication interfaces 627 may be used to communicate with one or more other systems. The communication interfaces 627 may include any circuits, components, software, etc. for communicating via one or more networks (e.g., networks 628). In some implementations, the communication interfaces 627 may include for example, one or more of a communications controller, receiver, transceiver, transmitter, port, conductors, software and/or hardware for communicating data/information.

The one or more networks 628 may be any type of communications network, such as a local area network (e.g., intranet), wide area network (e.g., Internet), or some combination thereof and may include any number of wired or wireless links. In general, communication over a network 628 may be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 6 illustrates one example computing system that may be used to implement the present disclosure. Other computing systems may be used as well. For example, in an embodiment, the user computing system 601 may include the model trainer 625 and the training data 626. In such implementations, the models 607, 617 may be both trained and used locally at the user computing system 601. In some of such implementations, the user computing system 601 may implement the model trainer 625 to personalize the models 607, 617.

Computing tasks discussed herein as being performed at certain computing device(s)/systems may instead be performed at another computing device/system, or vice versa. Such configurations may be implemented without deviating from the scope of the present disclosure. The use of computer-based systems allows for a great variety of possible configurations, combinations, and divisions of tasks and functionality between and among components. Computer-implemented operations may be performed on a single component or across multiple components. Computer-implemented tasks or operations may be performed sequentially or in parallel. Data and instructions may be stored in a single memory device or across multiple memory devices.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination. Databases and applications may be implemented on a single system or distributed across multiple systems. Distributed components may operate sequentially or in parallel.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “or” and “and/or” may be used interchangeably herein. Lists joined by a particular conjunction such as “or,” for example, may refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims discussed herein may be adapted, rearranged, expanded, omitted, combined, or modified in various ways without deviating from the scope of the present disclosure. Some implementations are described with a reference numeral for example illustrated purposes and are not meant to be limiting.

What is claimed is:

1. A computing system comprising:
one or more processors;
one or more non-transitory computer-readable media storing instructions that, are executable by the one or more processors to perform operations, the operations comprising:
receiving, from a user computing device, a user request query associated with contextual information;
determining, based on the user request query, computing instructions defining one or more parameters to satisfy the user request query;
inputting the computing instructions into a task generator, wherein the task generator, in response to the computing instructions, is configured to generate one or more executable tasks associated with satisfying the user request query in accordance with the one or more parameters;
generating a real-time communication channel between the computing system and the user computing device; and
transmitting, over the real-time communication channel, one or more command instructions to update a user interface of the user computing device to display the one or more executable tasks.

2. The computing system of claim 1, wherein the operations further comprise:
receiving, over the real-time communication channel task execution data, the task execution data generated in response to an execution of the one or more executable tasks.

3. The computing system of claim 2, wherein the operations further comprise:
determining, based on the task execution data, updated contextual information;
determining, based on the updated contextual information, updated computing instructions defining one or more updated parameters; and
inputting the updated computing instructions into the task generator, wherein the task generator, in response to the updated computing instructions, is configured to generate one or more updated executable tasks associated with the updated contextual information.

4. The computing system of claim 2, wherein the operations comprise:
validating the task execution data, wherein validating the task execution data comprises determining the task execution data satisfies at least one of: (i) a data format, (ii) a data quality, or (iii) a data consistency.

5. The computing system of claim 4, wherein the operations further comprise:
based on validating the task execution data, determining a status of the user request query, wherein the status is associated with an approval workflow.

6. The computing system of claim 1, wherein the contextual information is indicative of a product or service associated with the user request query.

7. The computing system of claim 6, wherein the product or service are associated with a financial product or financial service.

8. The computing system of claim 1, wherein the operations further comprise:
accessing data indicative of one or more previous user request queries, wherein the previous user request queries are associated with one or more previously executed tasks; and
computing, based on the previously executed tasks and the one or more executable tasks, at least one incomplete executable task.

9. The computing system of claim 8, wherein computing the at least one incomplete executable task comprises determining one or more duplicate executable tasks.

10. The computing system of claim 1, wherein the computing instructions comprise one or more nested computing instructions, the one or more nested computing instructions indicative of at least two types of contextual information.

11. The computing system of claim 10, wherein the one or more nested computing instructions consolidate at least one executable task common across the at least two types of contextual information.

12. The computing system of claim 1, wherein the operations further comprise:
based on the user request query, determining a plurality of types of contextual information; and
in response to determining the plurality of types of contextual information, programmatically generating the computing instructions, wherein the computing instructions synthesizes a set of non-duplicative executable tasks across the plurality of types of contextual information.

13. The computing system of claim 12, wherein programmatically generating the computing instructions comprises:
computing, a correlation between at least a first type of contextual information, a second type of contextual information, and respective parameters;
based on the correlation, determining additional or duplicative executable tasks between the first type of contextual information, the second type of contextual information, and the respective parameters; and
generating the computing instructions in accordance with the respective parameters.

14. A computer-implemented method comprising:
receiving, from a user computing device, a user request query associated with contextual information;
determining, based on the user request query, computing instructions defining one or more parameters to satisfy the user request query;
inputting the computing instructions into a task generator, wherein the task generator, in response to the computing instructions, is configured to generate one or more executable tasks associated with satisfying the user request query in accordance with the one or more parameters;
generating a real-time communication channel between a computing system and the user computing device; and
transmitting, over the real-time communication channel, one or more command instructions to update a user interface of the user computing device to display the one or more executable tasks.

15. The computer-implemented method of claim 14, further comprising:
receiving, over the real-time communication channel task execution data, the task execution data generated in response to an execution of the one or more executable tasks.

16. The computer-implemented method of claim 14, further comprising:
determining, based on the task execution data, updated contextual information;
determining, based on the updated contextual information, updated computing instructions defining one or more updated parameters; and
inputting the updated computing instructions into the task generator, wherein the task generator, in response to the updated computing instructions, is configured to generate one or more updated executable tasks associated with the updated contextual information.

17. The computer-implemented method of claim 16, further comprising:
validating the task execution data, wherein validating the task execution data comprises determining the task execution data satisfies at least one of: (i) a data format, (ii) a data quality, or (iii) a data consistency.

18. The computer-implemented method of claim 13, further comprising:
based on validating the task execution data, determining a status of the user request query, wherein the status is associated with an approval workflow.

19. The computer-implemented method of claim 18, wherein the contextual information is indicative of a product or service associated with the user request query.

20. A non-transitory computer-readable media storing instructions that are executable by one or more processors to perform operations, the operations comprising:
receiving, from a user computing device, a user request query associated with contextual information;
determining, based on the user request query, computing instructions defining one or more parameters to satisfy the user request query;
inputting the computing instructions into a task generator, wherein the task generator, in response to the computing instructions, is configured to generate one or more executable tasks associated with satisfying the user request query in accordance with the one or more parameters;
generating a real-time communication channel between a computing system and the user computing device; and
transmitting, over the real-time communication channel, one or more command instructions to update a user interface of the user computing device to display the one or more executable tasks.
